(19) United States
(12) Patent Application Publication
(10) Pub. No.: US 2009/0051846 A1
(43) Pub. Date: Feb. 26, 2009

(54) PLANAR LIGHT UNIT AND DISPLAY APPARATUS HAVING THE SAME

(76) Inventors: Yoshitake Horiuchi, Fujiyoshida-shi (JP); Tatsuro Yamada, Fujiyoshida-shi (JP)

Correspondence Address: BRINKS HOFER GILSON & LIONE, P.O. BOX 10395, CHICAGO, IL, 60610, US

(21) Appl. No.: 12/196,678

(22) Filed: Aug. 22, 2008

(30) Foreign Application Priority Data
Aug. 23, 2007 (JP) JP2007-217676
Jun. 10, 2008 (JP) JP2008-151708

(51) Int. Cl. F21V 21/00; F21V 3/00; G02F 1/1333

(52) U.S. Cl. 349/58; 362/311; 362/249

(57) ABSTRACT

A backlight unit is capable of preventing an error in positioning of a light-emitting diode light source. The backlight unit (1) includes a film-shaped lightguide plate (6) having at least one light source accommodating hole (6a), and at least one light source (L) having at least one light-emitting diode element disposed in the light source accommodating hole. A retaining portion (6b) provided on the peripheral wall surface of the light source accommodating hole pressingly engages the peripheral wall surface of the light source to support it.

### RELATED APPLICATIONS

This application claims priority under 35 U.S.C. §119 to Japanese Patent application No. JP2007-217676 filed on Aug. 23, 2007 and Japanese Patent application No. JP2008-151708 filed on Jun. 10, 2008, the entire contents of which are hereby incorporated by references.

### TECHNICAL FIELD

The present invention relates to a planar light unit that illuminates a liquid crystal display panel or the like, and also relates to a display apparatus having the planar light unit.

### RELATED CONVENTIONAL ART

Liquid crystal display apparatus for image display are widely used in displays of mobile phones, personal digital assistants (PDAs), mobile personal computers (PCs), automatic teller machines (ATMs), etc. These liquid crystal display apparatus employ a backlight unit that applies illuminating light to a light-transmitting liquid crystal display panel from the back thereof to enhance the luminance of the display screen on the front of the display panel.

The backlight unit uses a lightguide plate that guides light from a light source, e.g. a fluorescent lamp or light-emitting diode (LED) light source, and that emits the light toward a liquid crystal display panel from the entire area of a light exiting surface thereof. Japanese Patent Application Publication No. 2006-318830, for example, discloses a backlight unit having a plurality of LEDs opposed close to a side edge surface of a lightguide plate.

In the above-described backlight unit, the LEDs need to be positioned with a high accuracy with respect to the lightguide plate. However, a misalignment between the LEDs and the lightguide plate is likely to occur. If an error occurs in the positioning of the LEDs, the efficiency of light entering the lightguide plate degrades, resulting in a reduction in the luminance at the light exiting surface of the lightguide plate and a degradation of the luminance uniformity.

It has recently been demanded that backlight units should be thinner in order to reduce weight and thickness of end products using them. Under these circumstances, lightguide plates have also been reduced in thickness into a film-like thin structure. A backlight unit employing such a film-shaped lightguide plate also involves the above-described problem of the degradation of light entering efficiency caused by a misalignment between LEDs and the lightguide plate.

### SUMMARY OF THE INVENTION

The present invention has been made in view of the above-described problems with the conventional art. Accordingly, an object of the present invention is to provide a planar light unit capable of preventing a misalignment between an LED light source and a film-shaped lightguide plate. Another object of the present invention is to provide a display apparatus having the planar light unit of the present invention.

The present invention provides a planar light unit including a film-shaped lightguide plate having at least one light source accommodating hole, and the at least one light source having at least one light-emitting diode element and disposed in the light source accommodating hole. The at least one light source accommodating hole has a peripheral wall surface configured to pressingly engages the peripheral wall surface of the at least one light source to support the light source.

In this planar light unit, the light source is disposed in the light source accommodating hole and supported by the peripheral wall surface of the hole that pressingly engages the peripheral wall surface of the light source. Consequently, the light source is accurately retained in position on the lightguide plate. Thus, it is possible to maintain the efficiency of light entering the lightguide plate satisfactorily and to prevent a reduction in luminance at the light exiting surface of the lightguide plate and degradations in directivity and luminance uniformity.

Specifically, the peripheral wall surface of the at least one light source accommodating hole may be configured to pressingly engage the peripheral wall surface of the light source at a plurality of circumferentially spaced positions of the peripheral wall surface to support the light source. If the peripheral wall surface of the light source accommodating hole is designed to support the light source at a plurality of predetermined positions, it becomes easy to form the profile of the light source accommodating hole for positioning the light source. Hence, it also becomes easy to position the light source accurately.

More specifically, the peripheral wall surface of the at least one light source accommodating hole may have at least one elastic retaining portion extending inward of the hole. The retaining portion pressingly engages the peripheral wall surface of the light source to support the light source. The desired positioning of the light source can be effected, provided that the retaining portion is accurately formed at the predetermined position. Therefore, accurate positioning of the light source is facilitated.

As another specific example, at least one light source accommodating hole may comprise an elongated hole that accommodates and supports a plurality of light sources spaced from each other in a lengthwise direction of the elongated hole. If the light source accommodating hole has a size for accommodating only one light source, the peripheral wall of the hole may not be readily deformed sufficiently to insert and set the light source in the hole. However, such a problem can be solved by forming the light source accommodating hole into an elongated hole that can accommodate a plurality of light sources.

As a more specific example, the at least one light source include a peripheral wall surface which may have a front surface serving as a light exiting surface and a rear surface. The peripheral wall surface of the at least one light source accommodating hole may have a front portion that engages the front surface of the light source, a rear portion that faces the rear surface of the light source and has a retaining portion extending forward therefrom to engage the rear surface of the light source to press the light source toward the front portion.

In this case, the planar light unit may be arranged as follows. The at least one light source may include a single light source and the single light source includes a peripheral wall surface which may have left and right side surfaces extending between the front surface and the rear surface. The peripheral wall surface of the at least one light source accommodating hole has side portions extending rearward from the front portion. The side portions have respective retaining portions extending therefrom toward the light source to pressingly engage the left and right side surfaces of the single light source.

Unlike the above-described arrangement, the planar light unit may be arranged as follows. The at least one light source may include a single light source in the shape of a rectangular parallelepiped and the single light source includes a peripheral wall surface which may have a front surface serving as a light exiting surface, a rear surface and left and right side surfaces extending between the front surface and the rear surface. The peripheral wall surface of the light source accommodating hole has portions that engage corners between the rear surface and at least either one of the left and right side surfaces to press the light source forward.

As still another specific example, the at least one light source may include a single light source and the single light source includes a peripheral wall surface which may have a front surface serving as a light exiting surface and left and right side surfaces extending the front surface. The peripheral wall surface of the at least one light source accommodating hole may have a front portion that engages the front surface of the light source, and left and right side portions extending rearward from the front portion. The side portions have respective retaining portions extending therefrom toward the light source to pressingly engage left and right side surfaces of the single light source.

As a specific example different from the above, the at least one light source may include a single light source and the single light source includes a peripheral wall surface which may have a front surface serving as a light exiting surface, a rear surface and left and right side surfaces extending between the front and rear surfaces. The peripheral wall surface of the at least one light source accommodating hole may have a rear portion that engages the rear surface of the single light source, and side portions extending forward from the rear portion. The side portions have respective retaining portions extending therefrom toward the light source to pressingly engage left and right side surfaces of the single light source.

As still another specific example, the planar light unit may be arranged as follows. The at least one light source may include a single light source in the shape of a rectangular parallelepiped and the single light source includes a peripheral wall surface which may have a front surface serving as a light exiting surface, a rear surface and left and right side surfaces extending between the front surface and the rear surface. The peripheral wall surface of the at least one light source accommodating hole has a rear portion that engages the rear surface of the single light source, and portions that engage corners between the front surface and at least either one of the left and right side surfaces of the single light source to press the light source rearward.

As still another specific example, the planar light unit may be arranged as follows. The at least one light source may include a single light source in the shape of a rectangular parallelepiped and the single light source includes a peripheral wall surface which may have a front surface serving as a light exiting surface, a rear surface and left and right side surfaces extending between the front surface and the rear surface. The peripheral wall surface of the at least one light source accommodating hole is configured to pressingly engage corners of the single light source between the front surface and the side surfaces and corners of the same between the rear surface and at least either one of the side surfaces to support the light source.

In addition, the present invention provides a display apparatus including an image display panel and the above-described planar light unit that is disposed at the front or back of the image display panel. The planar light unit used in the display apparatus is capable of satisfactorily maintaining the efficiency of light entering the lightguide plate and hence capable of preventing a reduction in luminance at the light exiting surface of the lightguide plate and degradations in directivity and luminance uniformity. Accordingly, the display apparatus can realize favorable luminance characteristics with a thin structure.

In the display apparatus, the image display panel may be a liquid crystal display panel.

Embodiments of the present invention will be explained below with reference to the accompanying drawings. It should be noted that the scale of the figures used in the following explanation is properly changed to show each member in a recognizable size.

### BRIEF DESCRIPTION OF THE DRAWINGS

FIG. 1 is a sectional view schematically showing a main part of a mobile phone having a planar light unit and a display apparatus according to a first embodiment of the present invention.

FIG. 2 is an exploded perspective view of the backlight unit of the mobile phone shown in FIG. 1.

FIG. 3 is a top plan view of a film-shaped lightguide plate of the planar light unit shown in FIG. 1.

FIG. 4 is an enlarged top plan view showing a light source accommodating hole provided in the film-shaped lightguide plate shown in FIG. 3.

FIG. 5 is an enlarged top plan view showing light source accommodating holes provided in lightguide plates according to second to sixth embodiments of the present invention.

FIG. 6 is a top plan view of a film-shaped lightguide plate according to a seventh embodiment of the present invention.

FIG. 7 is an enlarged top plan view showing a light source accommodating hole in the seventh embodiment during and after the installation of LED light sources.

FIG. 8 is a top plan view showing a film-shaped lightguide plate according to an eighth embodiment of the present invention and a modification thereof.

FIG. 9 is an enlarged top plan view showing a light source accommodating hole provided on a film-shaped lightguide plate according to a ninth embodiment of the present invention and a modification thereof.

### DETAILED DESCRIPTION OF THE PREFERRED EMBODIMENTS

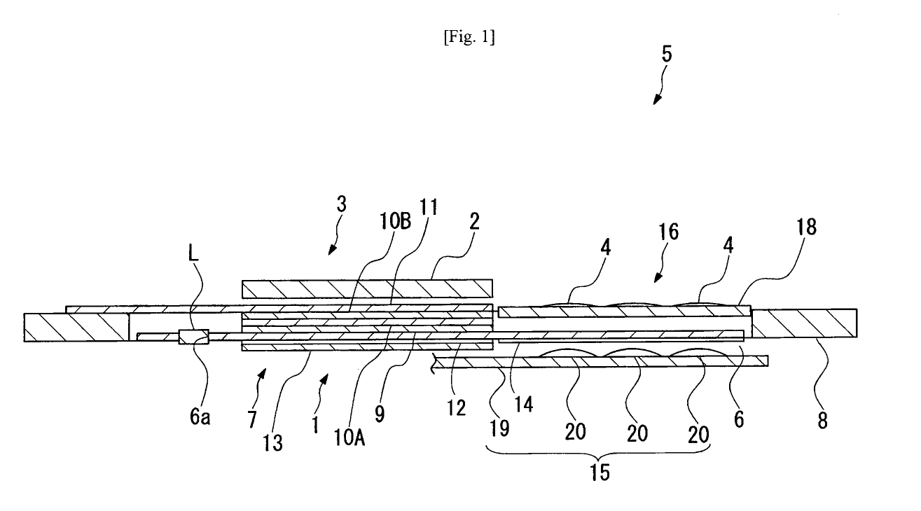

As shown in FIG. 1, a mobile phone 5 according to an embodiment of the present invention includes a display apparatus 3 having a liquid crystal display panel 2. The mobile phone 5 further includes a backlight unit 1 that illuminates the liquid crystal display panel 2 from the back thereof and a keypad 18 having operation keys 4.

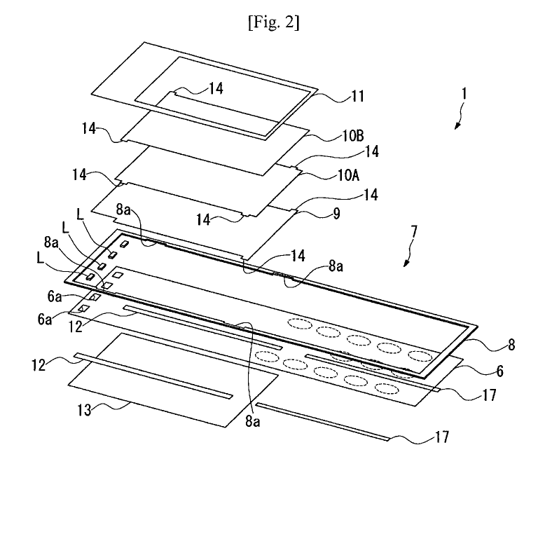

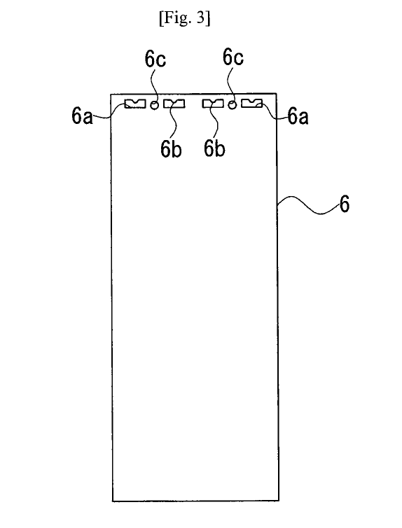

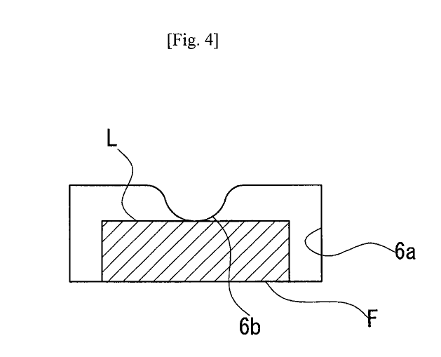

The backlight unit 1 includes LED light sources L having light-emitting diode elements (not shown) and a film-shaped lightguide plate unit 7 having a film-shaped lightguide plate 6 that guides light from the light sources L and that emits the light toward the liquid crystal display panel 2. As shown in FIG. 2, the film-shaped lightguide plate unit 7 includes a rectangular support frame 8, a reflecting sheet 13 bonded to the lower side of the support frame 8 with at least two strips of double-sided adhesive tape 12 bonded to two sides of the support frame 8, a stack of a film-shaped lightguide plate 6, a diffusing sheet 9 and first and second prism sheets 10A and 10B disposed inside the support frame 8 and successively stacked on the reflecting sheet 13, and a rim sheet 11 comprising double-sided adhesive tape bonded to the upper side of the support frame 8. The liquid crystal display panel 2 is disposed above the rim sheet 11.

The two strips of double-sided adhesive tape 12 are bonded to the respective lower sides of two longitudinally extending side portions of the support frame 8 and having portions exposed inside the support frame 8. The reflecting sheet 13 is bonded to the lower sides of the two strips of double-sided adhesive tape 12, and the longitudinally extending side edge portions of the lower side of the film-shaped lightguide plate 6 are bonded to the exposed portions at the upper sides of the two strips of double-sided adhesive tape 12. The support frame 8 has other two strips of double-sided adhesive tape 17 bonded to the lower side thereof. The two strips of double-sided adhesive tape 17 also have portions exposed inside the support frame 8. The longitudinally extending side edge portions of the lower side of the film-shaped lightguide plate 6 are bonded to the exposed portions at the upper sides of the two strips of double-sided adhesive tape 17. Each strip of double-sided adhesive tape 17 has a release sheet (not shown) applied to the lower side thereof. When the film-shaped lightguide plate unit 7 is to be mounted in an electronic device such as a mobile phone, the release sheet is removed, and each strip of double-sided adhesive tape 17 is bonded, for example, to the inner surface of the casing of the electronic device.

The diffusing sheet 9 and the first and second prism sheets 10A and 10B each have projections 14 formed on the longitudinally extending side edges thereof. The projections 14 are fitted into recesses 8a formed on the support frame 8. The stack of diffusing sheet 9 and first and second prism sheets 10A and 10B is fitted in the support frame 8 to dispose the projections 14 into the recesses 8a and bonded at the peripheral edge portions thereof with strips of double-sided adhesive tape (12 and 11) bonded to a lower side of the support frame 8.

The support frame 8 is pliable and punched with a press from a large-sized polyethylene terephthalate (PET) or stainless steel (SUS) film, for example. The thickness of the support frame 8 is set substantially equal to a total thickness of the film-shaped lightguide plate 6, the diffusing sheet 9 and the first and second prism sheets 10A and 10B, which are fitted in the support frame 8.

The film-shaped lightguide plate 6 is made of a pliable light-transmitting material. The film-shaped lightguide plate 6 guides light from the LED light sources L throughout it and emits the light from a light exiting surface (upper surface in the figures) thereof. The thickness of the film-shaped lightguide plate 6 is, for example, about 125 μm. In the illustrated film-shaped lightguide plate unit 7, the film-shaped lightguide plate 6 supported by the support frame 8 extends as far as underneath the operation keys 4 to illuminate not only the liquid crystal display panel 2 but also the operation keys 4.

The film-shaped lightguide plate 6 comprises, for example, a substrate layer (not shown) and resin layers (not shown) formed on the upper and lower sides of the substrate layer. Each resin layer has a plurality of microscopic optical configurations (e.g. convex dots) formed on a surface thereof to perform optical path conversion.

The substrate layer and the resin layers are formed by a transparent polycarbonate or acrylic resin, for example. The substrate layer is sheet-formed into a flat sheet shape by using roll forming process, for example. The resin layers are formed as follows. A coating of photo-setting organic resin that sets upon irradiation with ultraviolet (UV) radiation, e.g. one selected from among acrylic, urethane, urethane acrylate and epoxy acrylate resins, is applied to the upper and lower sides of the substrate layer, and microscopic optical configurations are formed on the surface of the resin coating by using a die. Thereafter, the resin coating is set by irradiation with ultraviolet radiation.

In the actual practice, a large-sized sheet formed as stated above is cut with a press or a cutter to obtain a film-shaped lightguide plate 6 of a predetermined shape and size.

The film-shaped lightguide plate 6 has a plurality of light source accommodating holes 6a for accommodating the LED light sources L, which are formed along one end edge (left end edge as seen in FIG. 2) thereof. Each light source accommodating hole 6a has a retaining portion 6b projecting inward in an arcuate shape to engage the rear surface of an LED light source L accommodated therein. Thus, the light source accommodating hole 6a supports the LED light source L at the front and rear surfaces of the LED light source L.

The film-shaped lightguide plate 6 has positioning holes 6c formed at predetermined positions near the light source accommodating holes 6a. The positioning holes 6c are used when each sheet is successively stacked during assembling. It should be noted that the location where the LED light sources L are disposed in the film-shaped lightguide plate 6 is not necessarily limited to the above-described end portion. For example, the LED light sources L may be disposed in the center of the film-shaped lightguide plate 6. It is also possible to dispose LED light sources L in the operation key-side end portion of the film-shaped lightguide plate 6 in addition to the above-described end portion thereof.

The diffusing sheet 9 is formed by dispersing silica particles or the like into a transparent resin, e.g. an acrylic resin, or a polycarbonate resin.

The first prism sheet 10A and the second prism sheet 10B are transparent sheet-shaped members that collect light from the diffusing sheet 9 and direct it upward. The first and second prism sheets 10A and 10B have on their upper sides a plurality of mutually parallel elongated prisms. The respective prisms of the first and second prism sheets 10A and 10B are disposed to intersect each other as viewed from above the prism sheets 10A and 10B, i.e. in plan view. To increase the upward directivity of light transmitted through the first and second prism sheets 10A and 10B, the prisms of the first prism sheet 10A are set in a direction perpendicular to the optical axis of light emitted from the LED light sources L and traveling through the film-shaped lightguide plate 6 from one end toward the other end thereof, and the prisms of the second prism sheet 10B are set parallel to the optical axis of light from the LED light sources L.

The reflecting sheet 13 is a metal sheet, film or foil having a light-reflecting function. In this embodiment, a film provided with an evaporated silver layer is employed as the reflecting sheet 13. It should be noted that an evaporated aluminum layer or the like may be used in place of the evaporated silver layer.

The LED light sources L are white LEDs mounted on a substrate (not shown) for light source. Each white LED is, for example, a semiconductor light-emitting diode element mounted on a substrate and sealed with a resin material. The semiconductor light-emitting element is, for example, a blue (wavelength λ: 470 to 490 nm) LED element or an ultraviolet (wavelength λ: less than 470 nm) LED element, which is formed by stacking a plurality of semiconductor layers of a gallium nitride compound semiconductor (e.g. InGaN compound semiconductor) on an insulating substrate, e.g. a sapphire substrate.

The resin material used to seal the semiconductor light-emitting element is formed by adding, for example, a YAG fluorescent substance into a silicone resin as a main component. The YAG fluorescent substance converts blue or ultraviolet light from the semiconductor light-emitting element into yellow light, and white light is produced by color mixing effect. It should be noted that various LED elements in addition to those described above can be used as the white LEDs. Places where the LED light sources L are mounted are not necessarily limited to the spaces in the light source accommodating holes 6a. The LED light sources L may be mounted at respective positions near an end surface of the film-shaped lightguide plate 6.

The backlight unit 1 is assembled as follows. First, the support frame 8 is fixed on a jig (not shown) serving as a base, and strips of double-sided adhesive tape 12 and 17 are stuck to the upper side of the support frame 8. The release sheets applied to the exposed sides of the strips of double-sided adhesive tape 12 are removed, and the reflecting sheet 13 is stuck to the exposed strips of double-sided adhesive tape 12. It should be noted that the release sheets applied to the strips of double-sided adhesive tape 17 are not removed. Thereafter, the support frame 8 is removed from the jig and turned upside down. The film-shaped lightguide plate 6 is placed on the reflecting sheet 13, and the longitudinally extending side edges of the film-shaped lightguide plate 6 are bonded to the portions of the strips of double-sided adhesive tape 12 that are exposed inside of the support frame 8. Next, a flexible printed substrate (not shown) having the LED light sources L which are mounted thereon is disposed to locate each LED light source L in the corresponding light source accommodating hole 6a of the film-shaped lightguide plate 6.

A sheet unit is assembled in advance which has the second prism sheet 10B, the first prism sheet 10A and the diffusing sheet 9 stuck to the lower side of the rim sheet 11 in the order mentioned. Specifically, after the second prism sheet 10B has been bonded at both longitudinal ends thereof to the rim sheet 11, the first prism sheet 10A and the diffusing sheet 9 are successively laid under the second prism sheet 10B and bonded together by using pieces of double-sided adhesive tape exposed between the projections 14 of these sheets. The sheet unit thus prepared is fitted into the support frame 8 from above, and thus the second prism sheet 10B, the first prism sheet 10A and the diffusing sheet 9 are mounted in the support frame 8. In addition, the rim sheet 11 is stuck to the upper side of the support frame 8. During this assembling process, the projections 14 of each sheet are fitted into the corresponding recesses 8a of the support frame 8. In this way, the backlight unit 1 is produced in which the reflecting sheet 13 and the rim sheet 11 are stuck to the lower and upper sides, respectively, of the support frame 8, and in which the film-shaped lightguide plate 6, the diffusing sheet 9 and the first and second prism sheets 10A and 10B are stacked between the reflecting sheet 13 and the rim sheet 11 inside the support frame 8.

The liquid crystal display panel 2 is a transmissive or semitransmissive liquid crystal display panel. In the case of a semitransmissive liquid crystal display panel 2, for example, it has a panel body having a liquid crystal material, e.g. TN liquid crystal or STN liquid crystal, sealed with a sealant in a gap between an upper substrate and a lower substrate, each having a transparent electrode layer, an alignment film and a polarizer. The semitransmissive liquid crystal display panel 2 further has a semitransmitting-reflecting sheet having both light-transmitting and -reflecting functions, and the semitransmitting-reflecting sheet is provided underneath the panel body.

The mobile phone 5 further includes a sheet-shaped key operation unit 16 having a keypad 18 and a switching mechanism 15 disposed underneath the keypad 18.

The operation keys 4 of the keypad 18 are made of a light-transmitting and pliable resin and have numerals or letters displayed thereon to enter a phone number, etc.

The switching mechanism 15 comprises, for example, a switch substrate 19 and tact switches 20 mounted thereon. When one operation key 4 is depressed, the corresponding tact switch 20 is pressed through the film-shaped lightguide plate 6 to perform an ON/OFF operation.

It should be noted that the keypad 18 is stuck to the upper side of the support frame 8 with double-sided adhesive tape or the like (not shown).

Thus, in the backlight unit 1 of this embodiment, each light source accommodating hole 6a engages the front and rear surfaces of the associated LED light source L at the inner surface of the light source accommodating hole 6a to support the LED light source L. Particularly, the retaining portion 6b of the light source accommodating hole 6a pressingly engages the rear surface of the LED light source L. Therefore, the LED light source L can be positioned with a high accuracy in the direction of the optical axis of light emitted from the LED light source L. In addition, the front surface F of the LED light source L, which is a light exiting surface thereof, is placed in close contact with the inner wall surface of the light source accommodating hole 6a. Therefore, satisfactory light entering efficiency can be obtained.

Accordingly, the display apparatus 3 and the mobile phone 5, which have the backlight unit 1, can be reduced in thickness. In addition, the LED light sources L can be positioned with a high accuracy with respect to the film-shaped lightguide plate 6. Therefore, the light entering efficiency can be maintained satisfactorily, and it is possible to prevent a reduction in luminance and degradations in directivity and luminance uniformity.

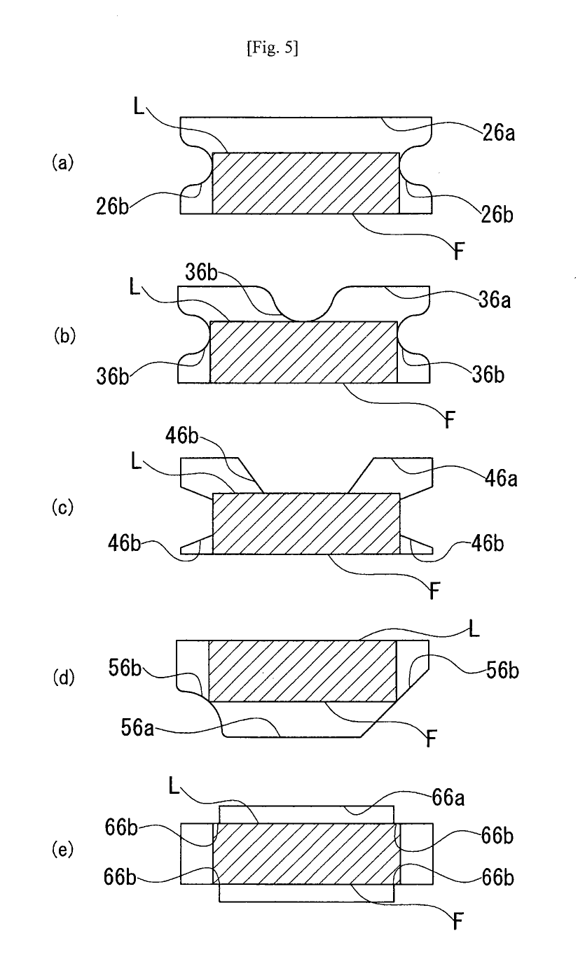

Second to sixth embodiments of the lightguide plate according to the present invention will be explained below with reference to parts (a) to (e) of FIG. 5. It should be noted that in the following embodiments the same constituent elements as those explained in the foregoing first embodiment are denoted by the same reference numerals as used in the first embodiment, and a description thereof is omitted herein.

In the second embodiment shown in part (a) of FIG. 5, a light source accommodating hole 26a has a pair of retaining portions 26b formed on a peripheral wall surface thereinto pressingly engage two opposite side surfaces, respectively, of an LED light source L. In the second embodiment, because the retaining portions 26b engage the opposite side surfaces of the LED light source L, the LED light source L can be positioned with a high accuracy in a direction perpendicular to the optical axis of light emitted from the LED light source L.

In the third embodiment shown in part (b) of FIG. 5, a light source accommodating hole 36a has three retaining portions 36b formed on the peripheral wall surfaces thereof. The retaining portions 36b engage the rear and two opposite side surfaces, respectively, of an LED light source L. Thus, in the third embodiment, the LED light source L can be positioned with a high accuracy in both the lengthwise and width directions of the hole by the three retaining portions 36b.

In the fourth embodiment shown in part (c) of FIG. 5, a light source accommodating hole 46a has three trapezoidal retaining portions 46b. That is, in the fourth embodiment, the LED light source L can be positioned with a high accuracy in both the lengthwise and width directions thereof by the three retaining portions 46b in the same way as in the third embodiment.

In the fifth embodiment shown in part (d) of FIG. 5, two corner portions of the peripheral wall surface inside a light source accommodating hole 56a project inward at the front surface F side of an LED light source L to form two retaining portions 56b. The retaining portions 56b engage the front surface F side corners of the LED light source L. That is, in the fifth embodiment, the retaining portions 56b engage the corners of the LED light source L. Therefore, the LED light source L can be positioned with a high accuracy in both directions along and perpendicular to the optical axis of light emitted therefrom. With this arrangement, a predetermined distance can be provided between the front surface F of the LED light source L and the film-shaped lightguide plate 6 by the retaining portions 56b engaging the front surface F side corners of the LED light source L. Therefore, this arrangement is particularly suitable for an LED light source L that should preferably be positioned away from the film-shaped lightguide plate 6 by a predetermined distance from the viewpoint of directivity.

In the sixth embodiment shown in part (e) of FIG. 5, a light source accommodating hole 66a has four retaining portions 66b rectangularly projecting inward from four corners thereof to retain the vicinities of four corners of an LED light source L at the front and back thereof, thereby positioning the LED light source L. That is, in the sixth embodiment, the LED light source L can be positioned with a predetermined distance between the film-shaped lightguide plate 6 and each of the front and rear surfaces of the LED light source L.

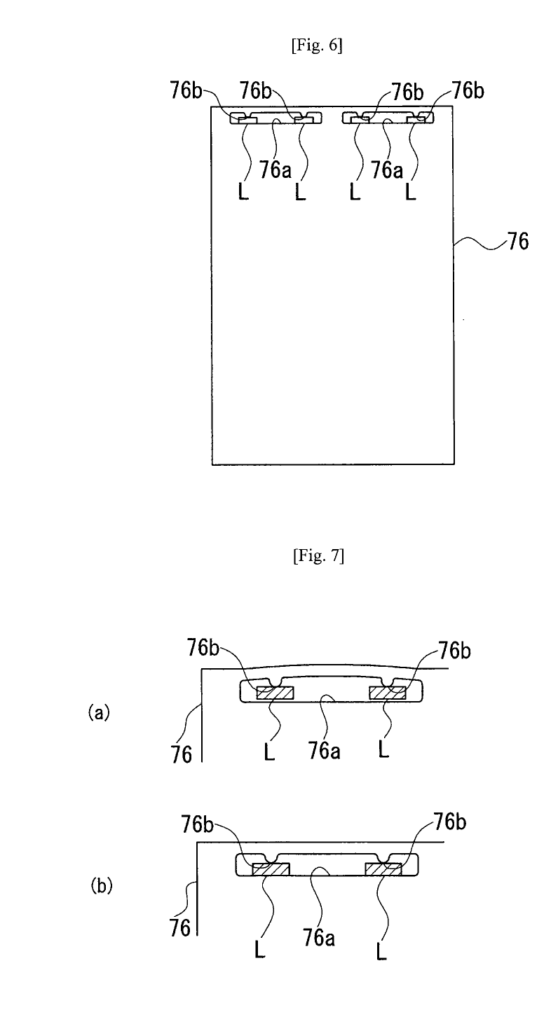

Seventh to ninth embodiments of the lightguide plate according to the present invention will be explained below with reference to FIGS. 6 to 9.

In the seventh embodiment shown in FIG. 6, each light source accommodating hole 76a is in the shape of an elongated hole in which two LED light sources L can be disposed with a predetermined spacing therebetween, and has two retaining portions 76b formed in correspondence to the two LED light sources L.

In a case where one LED light source L is disposed in one light source accommodating hole 6a as in the first embodiment, the retaining portion 6b may not be sufficiently elastic. In such a case, it may be difficult to fit the LED light source L into the light source accommodating hole 6a. In the seventh embodiment, each light source accommodating hole 76a is in the shape of an elongated hole to dispose two LED light sources L therein. Consequently, the peripheral wall of the light source accommodating hole 76a is readily deflectable, as shown in part (a) of FIG. 7, and hence the light source accommodating hole 76a is easy to expand. Accordingly, the LED light sources L can be fitted into the light source accommodating hole 76a easily as shown in part (b) of FIG. 7.

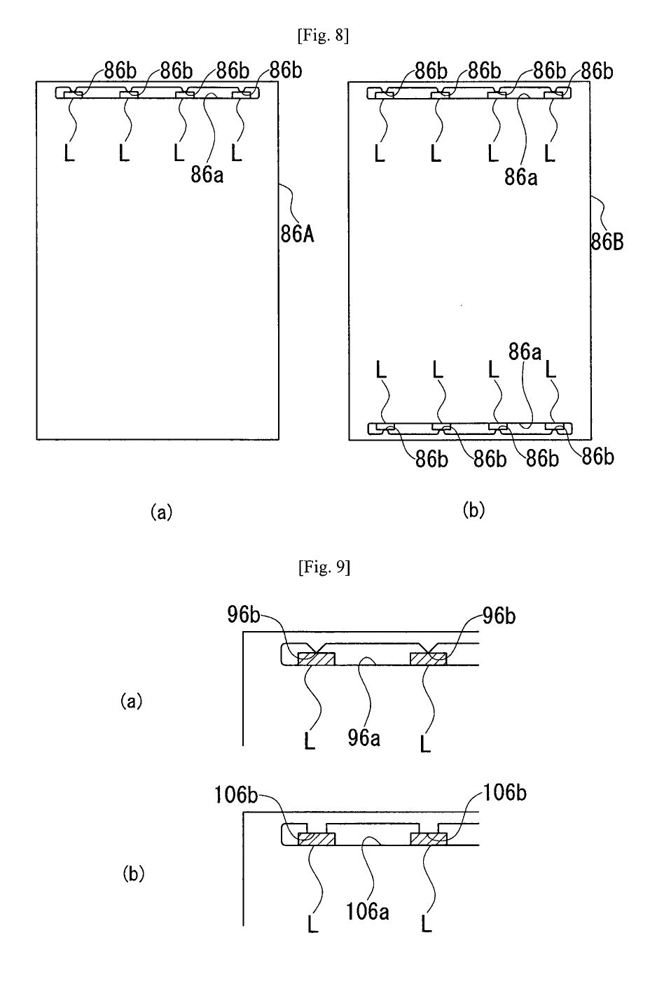

In the eighth embodiment shown in part (a) of FIG. 8, a light source accommodating hole 86a is in the shape of a further elongated hole that enables four LED light sources L to be disposed therein in a straight line at predetermined spacings. With this arrangement, the light source accommodating hole 86a is easier to receive the LED light sources than in the seventh embodiment. Thus, the operation of fitting the LED light sources L into the light source accommodating hole 86a is further facilitated.

Part (b) of FIG. 8 shows a modification of the eighth embodiment. In the modification, light source accommodating holes 86a are provided at both ends, respectively, of a film-shaped lightguide plate 86B, and four LED light sources L are disposed in each light source accommodating hole 86a. The LED light sources L disposed at one end of the film-shaped lightguide plate 86B may be used for the liquid crystal display panel 2, and the LED light sources L disposed at the other end of the film-shaped lightguide plate 86B may be used for the operation keys 4.

In the ninth embodiment shown in part (a) of FIG. 9, retaining portions 96b of a light source accommodating hole 96a are triangular in shape. Part (b) of FIG. 9 shows a modification of the ninth embodiment, in which retaining portions 106b of a light source accommodating hole 106a have a rectangular shape.

It should be noted that the present invention is not necessarily limited to the foregoing embodiments but can be modified in a variety of ways without departing from the scope of the present invention.

For example, although it is preferable to provide a retaining portion in a light source accommodating hole, as stated above, a projecting retaining portion need not necessarily be provided. That is, the light source accommodating hole may be configured in accordance with the size of an LED light source to be fitted therein so that flat inner surfaces of the hole engage the front and back surfaces of the LED light source when fitted in the hole. By so doing, the LED light source can be retained by the elasticity of the peripheral wall of the light source accommodating hole and thus can be positioned with a high accuracy.

The diffusing sheet 9 used in the above-described backlight unit 1 may be omitted. Although two prism sheets are used in the foregoing embodiments, the backlight unit 1 may have only one prism sheet.

Although the above-described display apparatus employs the liquid crystal display panel 2 as an image display panel, other types of image display panels may be used, for example, an electronic paper. In this case, the planar light unit according to the present invention is disposed as a front light unit at the front side of the electronic paper body.

1. A planar light unit comprising:
a film-shaped lightguide plate having at least one light source accommodating hole; and
at least one light source having at least one light-emitting diode element and disposed in the light source accommodating hole;
the at least one light source accommodating hole having a peripheral wall surface configured to pressingly engage a peripheral wall surface of the at least one light source to support the light source.

2. The planar light unit of claim 1, wherein the peripheral wall surface of the at least one light source accommodating hole is configured to pressingly engage the peripheral wall surface of the light source at a plurality of circumferentially spaced positions of the peripheral wall surface to support the light source.

3. The planar light unit of claim 1, wherein the peripheral wall surface of the at least one light source accommodating hole has at least one elastic retaining portion extending inward of the hole, the retaining portion pressingly engaging the peripheral wall surface of the light source to support the light source.

4. The planar light unit of claim 1, wherein the at least one light source accommodating hole comprises a single elongated hole that accommodates and supports a plurality of light sources spaced from each other in a lengthwise direction of the single elongated hole.

5. The planar light unit of claim 1, wherein the at least one light source accommodating hole comprises a plurality of elongated holes that are spaced from each other in a width direction of the film-shaped lightguide plate, the elongated hole each accommodating and supporting at least one light source therein.

6. The planar light unit of claim 1, wherein:
the peripheral wall surface of the at least one light source comprises a front surface serving as a light exiting surface and a rear surface; and,
the peripheral wall surface of the at least one light source accommodating hole comprises:
a front portion that engages the front surface of the light source; and
a rear portion that faces the rear surface of the light source, and has a retaining portion extending forward therefrom to engage the rear surface of the light source to press the light source toward the front portion.

7. The planar light unit of claim 6, wherein:
the at least one light source comprises a single light source and the peripheral wall surface of the single light source having left and right side surfaces extending between the front surface and the rear surface; and,
the peripheral wall surface of the at least one light source accommodating hole has side portions extending rearward from the front portion, the side portions having respective retaining portions extending therefrom toward the light source to pressingly engage the left and right side surfaces of the single light source.

8. The planar light unit of claim 6, wherein:
the at least one light source comprises a single light source in the shape of a rectangular parallelepiped and the peripheral wall surface of the single light source having the front surface serving as a light exiting surface, the rear surface and left and right side surfaces extending between the front surface and the rear surface; and,
the peripheral wall surface of the light source accommodating hole has portions that engage corners between the rear surface and at least either one of the left and right side surfaces of the light source to press the light source forward.

9. The planar light unit of claim 1, wherein:
the at least one light source comprises a single light source and the peripheral wall surface of the single light source having a front surface serving as a light exiting surface, a rear surface, and left and right side surfaces extending from the front surface to the rear surface; and,
the peripheral wall surface of the at least one light source accommodating hole has:
a front portion that engages the front surface of the single light source; and
left and right side portions extending rearward from the front portion, the side portions having respective retaining portions extending therefrom toward the light source to pressingly engage left and right side surfaces of the single light source.

10. The planar light unit of claim 1, wherein:
the at least one light source comprises a single light source and the peripheral wall surface of the single light source having a front surface serving as a light exiting surface, a rear surface and left and right side surfaces extending between the front and rear surfaces; and,
the peripheral wall surface of the at least one light source accommodating hole has:
a rear portion that engages the rear surface of the single light source; and
side portions extending forward from the rear portion, the side portions having respective retaining portions extending therefrom toward the light source to pressingly engage the left and right side surfaces of the single light source.

11. The planar light unit of claim 1, wherein:
the at least one light source comprises a single light source in the shape of a rectangular parallelepiped and the peripheral wall surface of the light source having a front surface serving as a light exiting surface, a rear surface and left and right side surfaces extending between the front surface and the rear surface; and,
the peripheral wall surface of the at least one light source accommodating hole has:
a rear portion that engages the rear surface of the single light source; and
portions that engage corners of the single light source between the front surface and at least either one of the left and right side surfaces to press the light source rearward.

12. The planar light unit of claim 1, wherein:
the at least one light source comprises a single light source in the shape of a rectangular parallelepiped and the peripheral wall surface of the single light source having a front surface serving as a light exiting surface, a rear surface and left and right side surfaces extending between the front surface and the rear surface; and,
the peripheral wall surface of the at least one light source accommodating hole is configured to pressingly engage corners of the single light source between the front surface and the side surfaces and corners of the same between the rear surface and the side surfaces to support the light source.

13. A display apparatus comprising:
an image display panel; and
the planar light unit of any one of claim 1 , the planar light unit being disposed at a front or back of the image display panel.

14. The display apparatus of claim 12, wherein the image display panel is a liquid crystal display panel.
